(19) United States
(12) Patent Application Publication
(10) Pub. No.: US 2003/0051071 A1
(43) Pub. Date: Mar. 13, 2003

(54) Modular software system and method

(76) Inventors: Thorarinn Stefansson, Reykjavik (IE); Thorsteinn H. Steinarsson, Kopavogur (IE)

Correspondence Address: KAPLAN & GILMAN , L.L.P., 900NROUTE 9 NORTH, WOODBRIDGE, NJ, 07095, US

(21) Appl. No.: 09/950,991

(22) Filed: Sep. 13, 2001

(51) Int. Cl. G06F 9/00

(52) U.S. Cl. 709/328

(57) ABSTRACT

The present invention provides a system and method for developing software applications through the use of executable code in the form of Filters.

The application requirements are analyzed and one or more Filter Graph descriptors are made for selection and relationship of the Filters. This determines the flow of data and the data processing behavior of the application. One or more Creators are associated with Filter Graphs by the use of Creator Groups. Filters are assembled and interconnected by a Plumber module. The Filters are connected by Pins.

Data flowing in a Filter Graph can be monitored by attaching Probes to the Pins. The Probes are managed by a Probe Manager and can be used by the application User Interface to visualize or store the information.

The application can be executed in three different Application Shells that that all have a built-in thread management utility called Thread Pool.

### FIELD OF THE INVENTION

The present invention relates to the field of computer software, and more particularly to a system for assembling code components into an application according to a selected system design.

### BACKGROUND OF THE INVENTION

Following the introduction of object oriented programming, object interfacing and object implementation rules were introduced to the programming world as a major innovation in the form of Microsoft COM (Component Object Model). A component is a reusable module of software in binary form that can be assembled to other components with relatively little effort. This allows programmers to create a desired program by assembling and/or embedding existing components. The major advantage of such a system is modularity, code reusability and management.

Additional directions in software design and the structure of applications, e.g. multi-tier applications, have since emerged. Today many tools exist that assemble COM/COM+ based components and its counterpart in Java, the Java Beans, e.g. Visual C++, Visual Basic and Java Builder, to build large flexible and manageable applications.

Microsoft efficiently uses COM components in their multi-media platform known as DirectShow, including such components as Filters, Pins, Graph-builder, and Filter-graphs. However, deficiencies exist due to the fact that the interconnections among the filters are inflexible, and monitoring of the system during debugging is difficult. Also, thread pools are dependant upon the particular application used, limiting flexibility.

### SUMMARY OF THE INVENTION

The present invention provides a system for the creation of software applications based on an executable application shell and dynamically linked components. The dynamically linked components are dynamically linked libraries (DLLs), e.g. libraries that contain executable modules (having compiled and linked source code). Each component fulfills the rules of the Microsoft component object model (COM). The main purpose of the shell is to provide executable application startup functions and manage the process threads.

The shell uses an operating system independent utility called ThreadPool to achieve effective and safe use of threads used by the application.

The basic components are processing units called filters. The filters are interconnected using contained objects called pins, thus forming an application layout plan referred to as a filter graph. The pins allow data to flow from one filter to another where each filter performs specific processing of the data.

The method of creating filter graphs and allowing them to share the available processing power of the computer they are executed on, are the major features of the invention. This accomplished by using components known as creator groups, creators and plumbers, and by a special utility known as thread pool. Another feature of the invention is data probing, e.g. a special way of gathering information about data flowing through a filter graph for visualization or storing.

To utilize the present invention, a programmer, having analyzed the requirements of a planned Application, will

identify the environment and select or create the Application Shell

decide when (on what external triggering events) the Filter Graph is to be created

select or make new creators that are suitable

identify how the system interacts with the external environment

select the key components (Filters) and define how they are to interact in the final system for processing data

organize the components into a Filter Graph, analyzes the flow of data through it and

define user interface (UI) components and probes.

### BRIEF DESCRIPTION OF THE DRAWINGS

FIG. 1 is an overview of the system of the invention in which the components thereof are schematically interrelated.

FIG. 2 is a detail view of a simple Application created according to the present invention, with Probes included for monitoring information flow between Filters.

### DETAILED DESCRIPTION OF THE INVENTION

The present invention provides a flexible, modular, software development system for the efficient creation of new Applications by the assembly of defined parts, (e.g. Application Shells, Creators, Plumbers, Filters and User Interface modules) according to assembly descriptions.

The term component is here a reusable piece of software in binary form (executable) that can be plugged into other components with relatively little effort. Each component contains multiple objects where each object is defined as a collection of related functions (or intelligence) and the function's associated state. Manipulation of each object and interoperability between objects is achieved through the use of properties and methods that are exposed to the outer world in structures known as interfaces.

Filters are components with common set of interfaces that allow communication with the Plumber, e.g. for manipulation of their properties. The Filters have a central processing function (Process) where the input is processed and the output is generated.

The Plumber is a component for assembling and connecting the Filters according to an assembly description and for mediating the communication between Filters and other Application components. The Plumber also maintains the internal states of the Filter Graph, i.e. the structure that shows the interrelationship between the filters.

The Assembly Description is a structured list of Filters and how they are interconnected into a Filter Graph. It also contains their properties. The Assembly Description is used by the Creators to assemble the filters into a graph.

A Filter Graph is a set of Filters assembled and connected by the Plumber. Each Filter performs a specific task and has its own set of properties.

Interoperability between Filters is achieved by embedded components known as Pins that have interfaces for transferring data. Pins are unidirectional and data flows from output pins of one Filter to input pins of another Filter. There may be zero to many input and/or output pins per Filter.

The Creators are components that control and instantiate the creation of Filter Graphs. Thus, the time when a Filter Graph is created is controlled by the Creators. The Creators have properties that specify how the Filter Graph is to be created, state managed and eventually destroyed. The creators belong to a Creator Group that specifies what Filter Graph is to be used. Each Creator Group can have many Creators and each Creator may create many instances of the Filter Graph components, by instantiating a Plumber through the Creator Group with an Assembly Description.

The Creators and Creator Groups are defined in an Application Description for a selected Application Shell. The Application Description also contains properties for the application and selection of the User Interface (UI) component(s) and probes.

The present invention is being developed under the tradename FilHarmony, and thus, we will refer to it by that name herein. The Application Shell is the nest of the FilHarmony components. It can be an executable or a component in a Non-FilHarmony application. In the last case it may contain proprietary components for interoperation between the FilHarmony components and the Non-FilHarmony application.

The application shell has a built-in thread management utility called Thread Pool. The purpose of the Thread Pool is to:

1) manage threads to provide safe and effective multi-threaded environment for the application. Multiprocess operating systems allow a number of applications to be executed simultaneously. Each application is executed in a seperate process and is alotted a central processor time depending on the assigned priority and it's demands. Some operating systems go one step further by defining threads of execution, where the threads are managed by a special thread manager. All applications are still run as a process, where one thread is automatically created to execute the application. The application can however create it's own threads to execute many tasks at the same time.

2) provide methods to synchronize access to shared resources. Running many tasks at the same time requires synchronizaton to shared resources that can be modified, e.g.

writable portion of memory or a disk file. Synchronization is achieved by locking the portion of the code that is using the resource so that only one thread can gain access to it at at time.

3) provide methods to execute tasks asynchronously. Most operating systems provide methods to associate interrupts or events with user defined procedures. Procedure is a piece of code with an entry point and interrupts are generated when device events occur i.e. data is available on a serial port. Instead of requesting an input and wait (synchronous read) an application can open the resource i.e. serial port for asynchronous access, issue a request with a procedure as an argument. The application doesn't wait for the input but is called back on the supplied procedure when the interrupt occurs.

4) provide methods to execute scheduled tasks. Timers with a procedure callback are provided by most operating systems. They are usually a limited resource.

The User Interface (UI) component is a configurable item in the Application Description. The UI may contain visualization of Probe information or property pages for Filter or Application properties.

The Probes are configurable components on the pins of the filters. They can be used to probe the communication going through the pins. The probes belong to the Probe Master

The Probe Master creates Probes and manipulates all data from them. User interface modules can hook into the Probe Master for access of specific Probes and monitoring of specific events. The hooking is defined in the Application Description.

The Probes are a set of items that monitor and act upon certain specified conditions. The Probe Master contains a table which lists the Probes and associates each Probe with a Pin. Each Pin represents a one-way communications path between two different Filters.

The Probe also contains one or more conditions that may be present on the Pin, and the action(s) to take upon the condition occurring. Conveniently, the Probe Master may be configured through a Graphical User Interface (GUI).

In an exemplary implementation, the GUI is presented to the user after the Filter Graph is designed and assembled. The user then inputs a value corresponding to the Probe desired to be configured. The user may then inputs a particular condition to search for on the Probe, as well as an action to take.

Preferably, the GUI will present each Probe with one or more options to take in response to the condition being present on that Probe. The GUI will also provide that a certain action (e.g. store a value, display a value, etc) will be taken when a set of conditions spanning multiple Probes is present.

As a general rule, the user may configure the Probe Master from the GUI to recognize one more conditions on one or more pins, and to generate the appropriate signals upon such condition occurring. This technique provides a centralized monitoring function that may be configured prior to execution of the software and which provides signals and other actions as required and/or specified upon the particular conditions occurring. Accordingly, debugging and software development is simplified. If the Filters are, for example, incorrectly assembled, then the wrong information will be transferred across the interconnecting Pins, and this state will be detected by the Probe Master.

The components of the invention system may be organized into three levels as described below.

Level One (Broad—Shell)

The Application Shell together with the Application Description defining the Probes and User Interface modules.

Level Two (Intermediate—Creation)

The Creators and Creator Groups, configured in the Application Description selecting the Assembly Description. This Assembly Description is the Description of what conditions should cause the Filters to be selected and assembled.

Level Three (Narrow—System)

Selection of the Filters assembled by the Plumber and connected through the Pins as defined in the Assembly Description.

A programmer that is using the invention to create a new application might proceed from the Broad to the Narrow.

Broad (Shell)

Identify the process environment in which the application is to be nested and select or create the Application Shell that is suitable.

Intermediate (Creation)

Identify when (on what external events) the Filter Graph is to be created. Select or make new creators that are suitable.

Narrow (System)

Identify how the system interacts with the external environment. Select the key components (Filters) and define how they interact in the final system for processing data. Organize them into a Filter Graph and analyze the flow of data through it. Define UI components and Probes.

Additional components of the invention, not described so far, are described below:

The FilterApp is one of the two key FilHarmony enabling objects (the other being PlumberSite) and is hosted by the Application Shell. There is only one instance of the FilterApp object in every FilHarmony application. The FilterApp object is a container for components that are shared by other components of the system, and provides access to these objects. Its main function though is to control the execution of the Filter Graph instances and share the available processing power among the running Graphs. This is accomplished by using a utility known as Thread Pool that is described below.

The Thread Pool is a Thread management utility with scaling parameters for adjusting the number of Threads offered for each of its services. It provides several services to applications:

Asynchronous Procedure (function) Calls (APC) where a procedure is invoked when a given event occurs.

Scheduled Procedure Calls (SPC) where a procedure is invoked after a given period of time.

Work Items—where procedures are queued to be invoked either on the same Thread or a different Thread of execution.

The Filters have access to these services through interfaces on the Plumber.

The PlumberSite is one of the two key FilHarmony enabling objects (the other being FilterApp) hosted by the Application Shell component and is a singleton as the FilterApp. It owns a list of all Creator Groups. It acts as a customizable layer interfacing the FilterApp and its contained objects to the Plumber. This enables the Plumber instances to utilize the services provided by the FilterApp object. These include Thread Pool, Probes, Logging, Application Configuration and individual Filter properties. The PlumberSite also hosts the Creator Groups and keeps track of all Plumber instances.

The Logger is message-queue based logging service, common for all objects in the FilHarmony application. Thus multiple Threads of execution share the same log-device (or file).

Notification is a method for a Filter to report its internal status or events to the PlumberSite through the Plumber.

The PropertyHandler is a utility for providing access to the Filter properties.

A Work Item is the item wherein procedures are queued to be invoked either on the same Thread or a different Thread of execution depending on programmer's choice, wherein the threads are of the same Thread priority, but divided into three different groups of sub-pools (slow, normal and fast) and a special group (for dynamically created and destroyed Threads), where each group is for the use at the discretion of the programmer for the execution of slow, normal or fast tasks (procedures), or special non-scaleable procedures, respectively.

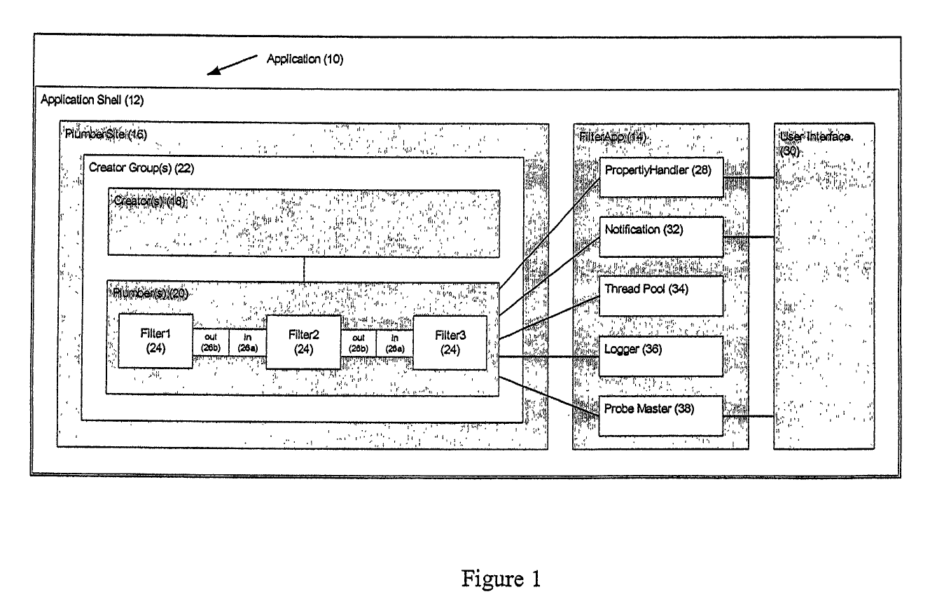

An exemplary Application is depicted in FIG. 1, wherein the component relationships are illustrated in simplified form.

Application Shell 12 contains FilterApp 14, PlumberSite 16 and the User Interface 30. The FilterApp 14 contains all shared components of an application like the Property Handler 28, Notification 32, Thread Pool 34, Logger 36 and Probe Master 38.

The Plumber Site 16 contains one or more Creator Groups 22 from which Creators 18 and Plumbers 20 are obtained. The Creators 18 instantiate one or more Plumbers 20 with one or more Filters 24.

In the illustration of FIG. 1, a single Creator Group 22, a single Creator 18, a single Plumber 20, and three Filters 24 are shown for reasons of simplicity and clarity. In actual practice, the creation of a typical Application would involve greater numbers of each component than shown here.

Each Filter 24 has one or more input Pins 26a and one or more output Pins 26b to establish a connection to, and communication of data with, other Filters 24 in Plumber 20.

The number of Pins 26 on a Filter 24 is determined by the programmer of Filter 24 depending the function to be performed by Filter 24.

The connections of Pins 26 between connected pairs of Filters 24 are configured in the Filter Graph. A Filter 24 can have as many input and output Pins 26 as the programmer desires.

In FIG. 1, Filter 1 24 has one output Pin 26b, Filter 2 24 has one input Pin 26a and one output Pin 26b and Filter3 24 has one input Pin 26a.

As all Pin 26 connections are universal according to the preferred embodiment of the invention, the output Pin 26b of Filter 1 24 can be connected directly to the input Pin 26a of Filter 3 24 in the Filter Graph, thus eliminating Filter 2 24. This only depends on the meaningfulness of such a connection and is decided upon by the designer of the Filter Graph.

Ancillary services that are accessible by Filters 24 through Plumber 20 during program running are provided by the FilterApp 14 in FIG. 1, some of which services are connected to User Interface 30. The service of Notification 32 connects to the assembled Filters 24, for providing information to the user through the User Interface 30 that a particular condition within the Filter exists. User Interface 30 will typically be a dialog box or some file by which a user of Application 10 interacts.

The Thread Pool 34 is not connected to the user interface.

A further function provided in this system is that of the Logger 36, which provides the service of logging, or recording, data to a file. However, the recorded data may be accessed through User Interface 30 upon request of the user. Typical information to be logged is user identification, use time, message recipient, Filter internal function calls etc. Logger 36 may or may not be connected to the User Interface 30.

Probes, internally connected to Pins 26 for monitoring data flow, transmit data information through Probe Master 38 to User Interface 30. Probes are connected to selected Pins 26 for monitoring communication of data between Filters 24 and providing that information to a Probe Master 38 that in turn selects a subset of that information, depending on Probe Master 38 configuration, and sends it to the User Interface 30.

The connection of Probe Master 38 to the User Interface 30 is configured in the Application description, which also defines the criteria to be applied by Probe Master 38 for the selection of the Probe information.

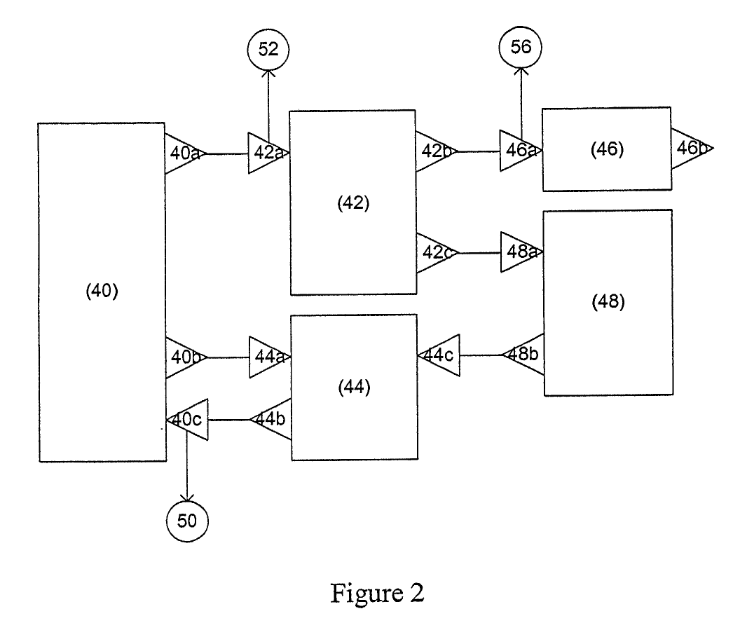

An example of a more focused and detailed view of a portion of the invention structure is shown in FIG. 2. FIG. 2 portrays a sample array of Filters 40, 42, 44, 46, 48 with Pins 40a, 40b, 40c, 42a, 42b, 42c, 46a, 46b, 48a, and 48b, and Probes 50, 52, 56 to show the core portion of a simple, operational, application. Filters 40-48 have been selected by a programmer as satisfying some application requirements, and are connected to one another by related Filter Pins (40a to 48b) as illustrated.

In FIG. 2 output Pins, e.g. 40a, are shown diagrammatically as triangles with the broad end connected to Filter 40, while input Pins, e.g. 42a, have the narrow end connected to Filter 42.

As shown in FIG. 2, Filter 40 has three Pins 40a to 40c that connect to Pins 42a on Filter 42 and Pins 44a and 44b of Filter 44; thus, Filter 40 is connected for two-way communication to Filter 44, but only one-way communication to Filter 42. By way of description, Pin 40a and 40b are designated output Pins and Pin 40c is an input pin. Similar input and output Pin relationships are depicted with respect to the other Filters in FIG. 2, whereas Filter 46 has only a single line of communication to Filter 42 through Pins 42b, 46a and Pin 46b on Filter 46 is not connected.

Continuing with FIG. 2, a series of Probes 50, 52 and 56, shown diagrammatically as circles, are connected to various Pins to monitor the information flow through that Pins between Filters.

Probe 50 is attached to Pin 40c, Probe 52 is attached to Pin 42a and Probe 56 is attached to Pin 46a. According to the discretion of the programmer, no probes are attached to other Pins in this Filter Graph. Each of Probes 50, 52, 56 connected at Pins in FIG. 2 transmits its information to a Probe Master 38 (see FIG. 1) for analysis and output to the User Interface 30.

As described herein, the present invention provides a novel modular software system and method for the utilization of existing computer code in an efficient manner. The system of the invention allows a programmer to define the requirements of a new Application and locate Filters to satisfy those requirements, assemble the Filters by means of Plumbers, including the use of Probes for monitoring of data flow.

While the present invention is described with respect to specific embodiments thereof, it is recognized that various modifications and variations thereof may be made without departing from the scope and spirit of the invention, which is more clearly understood by reference to the claims appended hereto.

What is claimed is:

1. A modular software system adapted for creating an Application from a plurality of new and established components, the system comprising:
a. an Application Shell for launching and hosting the system;
b. one or more Creators for providing intelligence on when to create, destroy, and change a state of application components; and
c. an Application Description for said Application Shell, said Application Description specifying the selected Creator components used in the application.

2. The system of claim 1 wherein said Application Shell hosts an operating system independent Thread management utility, the Thread management utility comprising:
a. a pool of Asynchronous Procedure Call Threads where a procedure is invoked when a given event occurs;
b. a pool of Scheduled Procedure Call Threads where a procedure is invoked after a given period of time;
c. one or more pools of Work Item Threads comprising:
1. provision for a client to select a specific Thread for the execution of procedures that belong to that client;
2. provision for a client to select a random Thread from a specific pool of Threads.

3. The system of claim 1 wherein the Application Description is further adopted for specifying User Interface components for visually presenting information on the configuration of the application.

4. The system of claim 1 wherein the Application Description is further adapted for configuring selected Probes for use in the application.

5. The system of claim 1 wherein the Creators are organized into Creator Groups.

6. The system of claim 5 wherein the Creator Groups contain a property for the selection of a specific Filter Graph.

7. The system of claim 1 wherein said Application Shell hosts a plurality of Filters, interconnected in a predetermined manner as specified in a Filter Graph.

8. The system of claim 3 further comprises a Probe Master that creates Probes and redirects information from the Probes to the User Interface.

9. The system of claim 3 further comprising a Notification interface for a Filter to report its internal status to the User Interface.

10. The system of claim 1 further comprising a PropertyHandler for:
a. providing access to Filter properties as stored in a configuration file;
b. providing access to a User Interface for manipulating Filter properties;
c. updating the properties in the configuration file; and
d. updating the Filter properties.

11. The system of claim 7 further comprising a Plumber for loading selected Filters according to a Filter Graph and for connecting selected ones of the Filters to one another through specified Pins.

12. The system of claim 11 further comprising a PlumberSite, hosted by the Application Shell, where the PlumberSite maintains a customizable list of Creator Groups and provides an interface layer for communication between the Plumbers and other parts of the application.

13. The system of claim 12 wherein said Filter Graph describes a predefined pattern for connecting selected ones of the plurality of Filters to establish application functionality.

14. The system of claim 13 wherein each Filter is comprised of:
a. zero or more input Pins and zero or more output Pins through which data flows and connection is established with other Filters; and
b. a central processing function, where all data from input Pins can be processed and the result delivered to selected output Pins.

15. The system of claim 14 wherein each pin connection is unidirectional and independent of data flow.

16. The system of claim 15 wherein the Pins further comprise:
a. means for probing data on said Pin; and
b. means for delivering data both asynchronously and synchronously, and for prioritizing said data.

17. The system of claim 16 further comprising memory allocation means for sharing buffers for data delivery between Filters.

18. The system of claim 8 wherein a Probe is connected for monitoring and analyzing data flowing from one Filter to another Filter through Pins.

19. A modular software system adapted for creating an Application from a plurality of established components, the system comprising:
a. a plurality of Filters for processing data, each Filter having zero or more input Pins and zero or more output Pins through which data can flow and each Filter may be connected to one or more other Filters through one or more Pins;
b. at least one Filter Graph describing a pattern for connecting selected ones of the plurality of Filters to form an Application;
c. a Plumber for parsing the at least one Filtergraph and loading selected Filters according to the Filtergraph and for connecting selected ones of the Filters to one another through the Pins;
d. a Creator for activating at least one Plumber according to the Application

20. The modular software system as described in claim 19, wherein a Probe is connected for communication with one or more Pins for monitoring and analyzing data flowing from one Filter to another Filter through the Pin.

21. The modular software system as described in claim 19, wherein the components are organized into hierarchical tiers.

22. The modular software system as described in claim 21, wherein there are three tiers.

23. The modular software system as described in claim 19, further comprising a Thread Pool for categorizing and sequencing tasks according to length of time needed.

24. The modular software system as described in claim 19, further comprising a Probe Master for receiving data from the Probe and analyzing the data flowing from one Filter to another Filter.

25. The modular software system as described in claim 19, further comprising a User Interface connected for providing a portal for input by and output to a user of the system.

26. A method for creating a computer application comprising the steps of:
a. defining Application requirements;
b. selecting a plurality of Filters from established Filters so as to carry out the Application requirements;
c. assembling the Filters to one another according to the Application requirements with a Pin connector for enabling information flow between Filters so connected;
d. providing zero or more Probes for monitoring information flow between code segments; and optionally;
e. connecting the one or more Probes respectively to one or more of the Pin connectors.

27. The method for creating a computer Application as described in claim 26, further comprising the step of creating a Filter Graph for outlining Application requirements and determining which Filters are to be used.

28. The method for creating a computer Application as described in claim 26, further comprising selecting and activating a Plumber for installing and assembling the Filters according to the Application requirements.

29. The method for creating a computer Application as described in claim 26, further comprising the step of connecting the one or more Probes to a Probe Master for analyzing and controlling information flow.

30. The method for creating a computer Application as described in claim 26, further comprising the step of providing a Thread Pool for regulating tasks according to length of time required.
